(19) United States
(12) Patent Application Publication
(10) Pub. No.: US 2007/0122629 A1
(43) Pub. Date: May 31, 2007

(54) Polymer interlayers comprising ethylene-vinyl acetate copolymer

(75) Inventors: Wenjie Chen, Amherst, MA (US); Aristotelis Karagiannis, Amherst, MA (US)

Correspondence Address: BRENC LAW;ANDREW BRENC, P.O. BOX 155, ALBION, PA, 16401-0155, US

(73) Assignee: Solutia, Inc.

(21) Appl. No.: 11/289,151

(22) Filed: Nov. 29, 2005

(51) Int. Cl. B32B 27/30; B32B 27/40; B32B 27/32

(52) U.S. Cl. 428/423.1; 428/522; 428/500; 428/523; 524/563

(57) ABSTRACT

The present invention is in the field of polymer interlayers used in multiple layer glass panels, and specifically the present invention is in the field of polymer interlayers comprising a polymer sheet comprising an ethylene-vinyl acetate copolymer.

### FIELD OF THE INVENTION

The present invention is in the field of polymer interlayers used in multiple layer glass panels, and specifically the present invention is in the field of polymer interlayers comprising a layer of ethylene-vinyl acetate copolymer.

### BACKGROUND

Polymer sheets that can be used as interlayers in light-transmitting, multiple layer laminates, such as safety glass or polymeric laminates, typically comprise poly(vinyl butyral). Safety glass generally refers to a transparent laminate comprising a poly(vinyl butyral) sheet disposed between two panes of glass. Safety glass often is used to provide a transparent barrier in architectural and automotive openings. Its main function is to absorb energy, such as that caused by a blow from an object, without allowing penetration through the opening.

Although poly(vinyl butyral) is well suited in general for use as a polymer sheet in safety glass interlayers, alternative materials are often useful as well. For example, ionomeric polymer and polyurethane have both been used as interlayers in glazing laminates. Interlayer materials are chosen for, among other reasons, improved handling, reduced cost of production, and improved performance. Alternatives to poly(vinyl butyral) interlayers could be useful, for example, if those alternatives showed improved performance or were less expensive to manufacture.

One particularly useful polymer is ethylene-vinyl acetate copolymer, or EVA. Prior to use in glazing interlayers, ethylene-vinyl acetate copolymer is typically modified in order to impart the desired clarity and performance characteristics (see, for example, U.S. Pat. No. 5,415,909). Modifications to ethylene-vinyl acetate copolymer that improve clarity include the use of mono-substituted benzaldehyde, and the use of thermosetting compounds (see, for example, U.S. Pat. Nos. 5,352,530 and 4,935,470). These modifications can result, however, in less than ideal thermostability in the finished laminate.

Accordingly, further improved ethylene-vinyl acetate copolymer materials for use as an interlayer or part of an interlayer in multiple layer glazing panels are needed in the art.

### SUMMARY OF THE INVENTION

It has now been surprisingly discovered, according to the present invention, that interlayers comprising ethylene-vinyl acetate copolymer incorporating a reaction product of a di-substituted benzaldehyde and a polyhydric alcohol or polyhyrdric alcohol derivative have excellent clarity and thermostability.

### BRIEF DESCRIPTION OF THE DRAWINGS

FIG. 1 represents a schematic cross sectional view of one embodiment of an interlayer of the present invention.

### DETAILED DESCRIPTION

The present invention is directed to interlayers that can be used in multiple layer laminated glazing constructs such as those used in architectural applications and automotive windshield applications. Interlayers of the present invention incorporate one or more layers of ethylene-vinyl acetate copolymer, wherein the ethylene-vinyl acetate copolymer layer comprises an ethylene-vinyl acetate copolymer that incorporates the reaction product of a polyhydric alcohol or polyhyrdric alcohol derivative and one or more di-substituted benzaldehydes, as will be described in detail, below. As used herein, “polyhydric alcohol/di-substituted benzaldehyde modified EVA” means ethylene-vinyl acetate copolymer that comprises, as an added agent, the reaction product of a polyhydric alcohol or polyhydric alcohol derivative and a di-substituted benzaldehyde, as will be described in detail, below.

In various embodiments of the present invention, an interlayer comprises a polymer sheet comprising polyhydric alcohol/di-substituted benzaldehyde modified EVA. In various embodiments of the present invention, an interlayer consists of or consists essentially of a polymer sheet of polyhydric alcohol/di-substituted benzaldehyde modified EVA.

Interlayers of the present invention also include multiple layer interlayers that are formed by laminating a polymer sheet comprising polyhydric alcohol/di-substituted benzaldehyde modified EVA with one or more other polymer layers, as is known in the art. For example, one or more conventional polymer sheets, as described in detail below, can be disposed in contact with the polymer sheet comprising polyhydric alcohol/di-substituted benzaldehyde modified EVA to form a stack, and the stack can then be laminated to form an interlayer. Further, one or more polymer films, as described in detail below, can be incorporated into multiple layer interlayers.

Examples of multiple interlayer constructs of the present invention include, without limitation, the five constructs given below, wherein “polyhydric alcohol/di-substituted benzaldehyde modified EVA” is abbreviated “modified EVA”:
polymer sheet//modified EVA//polymer sheet modified EVA//modified EVA
modified EVA//polymer film//modified EVA
polymer sheet//polymer film//modified EVA
modified EVA//polymer sheet//modified EVA

and variations thereof, including multiples, wherein multiple occurrences of a type of layer can have the same composition or a different composition.

In various embodiments of the present invention, an interlayer comprises a polymer sheet produced by coextrusion or extrusion coating, wherein the interlayer has more than one polymer sheet that comprises, consists of, or consists essentially of polyhydric alcohol/di-substituted benzaldehyde modified EVA. In general, for any embodiment of the present invention in which a polymer sheet comprising polyhydric alcohol/di-substituted benzaldehyde modified EVA is laminated with one or more other polymer sheets to form a multiple layer interlayer laminate, there is an equivalent embodiment in which multiple polymer sheets are formed in a single interlayer via coextrusion or extrusion coating, as is known in the art, to form an interlayer comprising at least one polymer sheet comprising polyhydric alcohol/di-substituted benzaldehyde modified EVA.

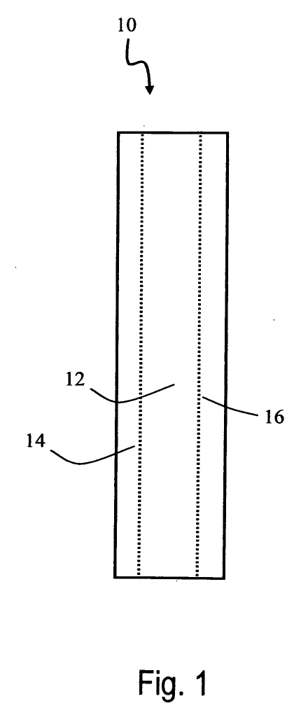

An example of a coextruded interlayer embodiment is shown generally in FIG. 1 at 10. As shown in FIG. 1, an interlayer 10 that has been produced through a co-extrusion or extrusion coating process comprises a first polymer sheet 12 comprising polyhydric alcohol/di-substituted benzaldehyde modified EVA, a second polymer sheet 14 comprising a second polymer material, and a third polymer sheet 16 comprising a third polymer material. The three polymer sheets shown in FIG. 1 correspond to a laminated interlayer having a polymer sheet comprising polyhydric alcohol/di-substituted benzaldehyde modified EVA disposed between two other polymer sheets. In one embodiment, for example, a coextruded embodiment according to FIG. 1 comprises a polymer sheet of polyhydric alcohol/di-substituted benzaldehyde modified EVA disposed between two polymer sheets of polyurethane.

In various embodiments of the present invention, interlayers are formed as shown in FIG. 1, with the layers reversed, wherein a polymer sheet is disposed between two polymer sheets of polyhydric alcohol/di-substituted benzaldehyde modified EVA.

In further embodiments of the present invention a polymer sheet comprising polyhydric alcohol/di-substituted benzaldehyde modified EVA is used to form a bilayer. Bilayers of the present invention comprise at least one layer of polyhydric alcohol/di-substituted benzaldehyde modified EVA and an adjacent polymer sheet or polymer film, with the polymer layers disposed on a rigid substrate, for example glass or plastic.

In various embodiments of the present invention—for example those in which coextrusion or extrusion coating techniques are not used—a prelamination step is included in which two or more polymer sheets or polymer films are disposed in contact with each other in the desired configuration, and heat and/or pressure is applied to “tack” the layers together sufficiently to allow for handling of the layers as a single unit. The prelaminated stack of layers can be used immediately or rolled or stacked for later use in lamination processes.

### POLYHYDRIC ALCOHOL/DI-SUBSTITUTED BENZALDEHYDE MODIFIED ETHYLENE-VINYL ACETATE COPOLYMER

As used herein, “EVA”, refers to ethylene-vinyl acetate copolymer.

In various embodiments of the present invention, ethylene-vinyl acetate copolymer resins of the present invention comprise, on a weight per weight basis, 40-95 weight percent, 60 to 92 weight percent, or 65-85 weight percent:

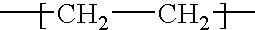

with the remainder being all, or substantially all of the following vinyl acetate component:

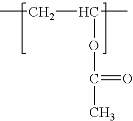

EVA can be prepared by any conventional method, as is known in the art, including, for example, but not limited to, the high pressure method and the emulsification method.

To the resin component of the EVA described above, a reaction product of a polyhydric alcohol or a polyhydric alcohol derivative and a di-substituted benzaldehyde is added in an amount sufficient to improve clarity of the finished polymer sheet. In various embodiments, the reaction product of a polyhydric alcohol or a polyhydric alcohol derivative and a di-substituted benzaldehyde is added to the resin in an amount of 0.01 to 5 phr, 0.05 to 3 phr, or 0.05 to 1 phr, wherein “phr” means “parts per hundred resin,” on a weight basis.

Polyhydric alcohol and polyhydric alcohol derivatives of the present invention include, for example and without limitation, pentaerythritol, mannitol, sorbitol, dipentaerythritol, and mixtures thereof. In a preferred embodiment, the polyhydric alcohol is sorbitol.

Di-substituted benzaldehydes of the present invention include those having the general formula:

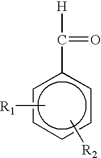

wherein R₁ and R₂ are the same or different, and are selected from the group consisting of alkyls and cyclic alkyls having 1 to 10 carbon atoms, NO₂, CN, COOH, Cl, F, Br, and the like. Specific examples of di-substituted benzaldehydes include 3,4-dimethylbenzaldehyde; 3,4-diethylbenzaldehyde; 3,4-dibutylbenzaldehyde; 3,4-dihexylbenzaldehyde; 3-chloro-4-methylbenzaldehyde, and the like.

In various embodiments of the present invention, the reaction product of a polyhydric alcohol or polyhydric alcohol derivative and a di-substituted benzaldehyde is 1,3:2,4-bis(3′4′-dimethylbenzylidene)sorbitol, which is available as Millad® 3988 from Milliken Chemical (Spartanburg, S.C.).

Other compounds that are useful with the present invention as a modifier for improving the clarity of EVA are traditional nucleating agents, for example aromatic carboxylic-acid salts (for example, sodium benzoate), organophosphate salts and phosphate esters, norbornane carboxylic-acid salt, sulfonamide (for example, p-tallow toluenesulfonamide), carboxylic acid esters (for example, PEG 600 Dilaurate), carboxylic acid salts, and the like. Talc and other inorganic fillers with very small particle size have also been found to have a nucleating effect.

In various embodiments, the ethylene-vinyl acetate copolymer polymer sheet has a thickness of at least 0.02 millimeters, 0.1 millimeters, 0.2 millimeters, 0.5 millimeters, 1.0 millimeters, 5.0 millimeters, 10 millimeters, 15 millimeters, or at least 20 millimeters.

Polyhydric alcohol/di-substituted benzaldehyde modified EVA polymers of the present invention can further include any conventional performance improvement agents, including, but not limited to, adhesion promoters and UV stabilizers.

Polymer Sheet

As used herein, a “polymer sheet” means any thermoplastic polymer composition formed by any suitable method into a thin layer for use in combination with a layer of polyhydric alcohol/di-substituted benzaldehyde modified EVA to form an interlayer that provides adequate penetration and glass retention properties to laminated glazing panels. Plasticized poly(vinyl butyral) is most commonly used to form polymer sheets. As described in this section, “polymer sheets” specifically do not include polyhydric alcohol/di-substituted benzaldehyde modified EVA, which are described above. The descriptions in this section for polymer sheets apply to coextruded or extrusion coating embodiments that correspond to polymer sheets in laminated embodiments.

The following section describes the various materials that can be used to form polymer sheets, for example those shown as elements 14 and 16 in FIG. 1.

In various embodiments of the present invention, polymer sheets can be between 0.01 and 3.0 millimeters, 0.1 to 2.0 millimeters, 0.25 to 1.0 millimeters, or 0.3 to 0.7 millimeters in thickness.

The polymer sheets of the present invention can comprise any suitable polymer, and, in a one embodiment, as exemplified above, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives, including plasticizers, disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In further embodiments the polymer sheet comprises poly(vinyl butyral) and one or more other polymers. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known acetalization processes that involve reacting poly(vinyl alcohol) (PVOH) with butyraldehyde in the presence of an acid catalyst, followed by neutralization of the catalyst, separation, stabilization, and drying of the resin. Details of suitable processes for making poly(vinyl butyral) are known to those skilled in the art (see, for example, U.S. Pat. No. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Missouri as Butvar™ resin.

In various embodiments, resin used to make the polymer sheet comprising poly(vinyl butyral) comprises 10 to 35 weight percent (wt. %) hydroxyl groups calculated as poly(vinyl alcohol), 13 to 30 wt. % hydroxyl groups calculated as poly(vinyl alcohol), or 15 to 22 wt. % hydroxyl groups calculated as poly(vinyl alcohol). The resin can also comprise less than 15 wt. % residual ester groups, 13 wt. %, 11 wt. %, 9 wt. %, 7 wt. %, 5 wt. %, or less than 3 wt. % residual ester groups calculated as poly(vinyl acetate), with the balance being an acetal, preferably butyraldehyde acetal, but optionally including other acetal groups in a minor amount, e.g., a 2-ethyl hexanal group (see, for example, U.S. Pat. No. 5,137,954).

In various embodiments, the polymer sheet comprises poly(vinyl butyral) having a molecular weight of at least 30,000, 40,000, 50,000, 55,000, 60,000, 65,000, 70,000, 120,000, 250,000, or at least 350,000 grams per mole (g/mole or Daltons). Small quantities of a dialdehyde or trialdehyde can also be added during the acetalization step to increase molecular weight to at least 350 g/m (see, for example, U.S. Pat. Nos. 4,902,464; 4,874,814; 4,814,529; and, 4,654,179). As used herein, the term “molecular weight” means the weight average molecular weight.

Various adhesion control agents can be used in polymer sheets of the present invention, including sodium acetate, potassium acetate, and magnesium salts. Magnesium salts that can be used with these embodiments of the present invention include, but are not limited to, those disclosed in U.S. Pat. No. 5,728,472, such as magnesium salicylate, magnesium nicotinate, magnesium di-(2-aminobenzoate), magnesium di-(3-hydroxy-2-napthoate), and magnesium bis(2-ethyl butyrate)(chemical abstracts number 79992-76-0). In various embodiments of the present invention the magnesium salt is magnesium bis(2-ethyl butyrate).

Additives may be incorporated into the polymer sheet to enhance its performance in a final product. Such additives include, but are not limited to, the following agents: antiblocking agents, plasticizers, dyes, pigments, stabilizers (e.g., ultraviolet stabilizers), antioxidants, flame retardants, IR absorbers, and combinations of the foregoing additives, and the like, as are known in the art.

In various embodiments of polymer sheets of the present invention, the polymer sheets can comprise 20 to 60, 25 to 60, 20 to 80, or 10 to 70 parts plasticizer per one hundred parts of resin. Of course other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (T_{g}) of the poly(vinyl butyral) sheet. In general, higher amounts of plasticizer are added to decrease the T_{g}. Poly(vinyl butyral)polymer sheets of the present invention can have a T_{g} of, for example, 50° C. or less, 40° C. or less, 35° C. or less, 30° C. or less, 25° C. or less, 20° C. or less, and 15° C. or less.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779 and C₆ to C₈ adipate esters, such as hexyl adipate. In various embodiments, the plasticizer used is dihexyl adipate and/or triethylene glycol di-2ethylhexanoate.

In various other embodiments of the present invention, polymer sheets comprise a polymer selected from the group consisting of poly(vinyl butyral), poly(vinyl chloride), poly(ethylene-co-vinyl acetate), poly(ethylene-co-ethyl acrylate), ionomers of partially neutralized ethylene/(meth)acrylic acid copolymer (such as Surlyn® from DuPont), polyethylene, polyethylene copolymers, polyurethane, or any other suitable polymeric material.

Polymeric resins can be thermally processed and configured into sheet form according to methods known to those of ordinary skill in the art. As used herein, “resin” refers to the polymeric (for example poly(vinyl butyral) or poly(vinyl chloride)) component of a polymer composition. Resin will generally have other components in addition to the polymer, for example, components remaining from the polymerization process. Resin is mixed with a plasticizer, if required, and optionally other additives, for example, performance enhancing agents, and heated to form a “melt.”

One exemplary method of forming a poly(vinyl butyral) sheet comprises extruding molten poly(vinyl butyral) comprising resin, plasticizer, and additives—the melt—by forcing the melt through a sheet die (for example, a die having an opening that is substantially greater in one dimension than in a perpendicular dimension). Another exemplary method of forming a poly(vinyl butyral) sheet comprises casting a melt from a die onto a roller, solidifying the resin, and subsequently removing the solidified resin as a sheet.

Coextrusion and extrusion coating are well known in the art. In one exemplary method of forming a PU/EVA/PU interlayer by coextrusion, where PU is polyurethane, polyurethane resin, including additives, and an EVA resin of the present invention, including additives, are fed into two single-screw extruders separately. Extruder temperatures are set appropriately for polyurethane, for example, at 150° C.-225° C. or 160° C.-180° C., and for EVA, for example, at 200° C.-290° C. or 240° C.-260° C. The two resins are heated to form melts, which are pumped separately into two outer-layer channels and a inner-layer channel of a three-manifold coextrusion die. The melts are then forced through a die-lip to form an interlayer having an EVA polymer sheet disposed between two polyurethane polymer sheets. In any of these embodiments, layer thicknesses can be the same as given elsewhere herein for non-extruded embodiments. In other embodiments, the layers can be reversed to produce a coextruded interlayer having a polyurethane polymer sheet disposed between two EVA polymer sheets.

Polymer Film

As used herein, a “polymer film” means a relatively thin and rigid polymer layer that functions as a performance enhancing layer. Polymer films differ from polymer sheets, as used herein, in that polymer films do not themselves provide the necessary impact resistance and glass retention properties to a multiple layer glazing structure, but rather provide performance improvements, such as infrared absorption character. Poly(ethylene terephthalate) is most commonly used as a polymer film.

Polymer films used in the present invention can be any suitable film that is sufficiently rigid to provide a relatively flat, stable surface, for example those polymer films conventionally used as a performance enhancing layer in multiple layer glass panels. The polymer film is preferably optically transparent (i.e. objects adjacent one side of the layer can be comfortably seen by the eye of a particular observer looking through the layer from the other side), and usually has a greater, in some embodiments significantly greater, tensile modulus regardless of composition than that of the adjacent polymer sheet. In various embodiments, the polymer film comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers and the like. In various embodiments, the polymer film comprises materials such as re-stretched thermoplastic films having the noted properties, which include polyesters. In various embodiments, the polymer film comprises or consists of poly(ethylene terephthalate), and, in various embodiments, the poly(ethylene terephthalate) has been biaxially stretched to improve strength, and/or has been heat stabilized to provide low shrinkage characteristics when subjected to elevated temperatures (for example, less than 2% shrinkage in both directions after 30 minutes at 150° C.).

In various embodiments, the polymer film can have a thickness of 0.013 millimeters to 0.40 millimeters, 0.025 millimeters to 0.2 millimeters, or 0.04 to 0.06 millimeters. The polymer film can optionally be surface treated or coated with a functional performance layer to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known (see, for example, U.S. Pat. Nos. 4,017,661 and 4,786,783), the metal layer(s) may optionally be electrically resistance heated for defrosting or defogging of any associated glass layers. Various coating and surface treatment techniques for poly(ethylene terephthalate) film and other polymer films that can be used with the present invention are disclosed in published European Application No. 0157030. Polymer films of the present invention can also include a hardcoat and/or and antifog layer, as are known in the art.

The present invention includes multiple layer glazing panels, and particularly glass panels, comprising any interlayers of the present invention.

The present invention includes methods of making interlayers and multiple layer glazing panels, and particularly glass panels, comprising forming any of the interlayers and glazing panels of the present invention by the methods described herein.

The present invention includes multiple layer glazing panels, and specifically multiple layer glass panels such as architectural safety glass and automobile windshields, comprising any of the interlayers of the present invention.

The present invention includes methods of manufacturing an interlayer, comprising using a coextrusion technique or extrusion coating technique to form any of the interlayers of the present invention.

The present invention includes methods of manufacturing a multiple layer glass panel, comprising disposing any of the interlayers of the present invention, with or without additional polymeric layers, between two panes of glass and laminating the stack.

The present invention includes methods of securing an enclosed space, comprising disposing in one or more openings that provide access to said space a multiple layer glass panel of the present invention.

Also included in the present invention are stacks or rolls of any of the polymer interlayers of the present invention disclosed herein.

In addition to the embodiments given above, other embodiments comprise a rigid glazing substrate other than glass. In these embodiments, the rigid substrate can comprise acrylic such as Plexiglass®, polycarbonate such as Lexan®, and other plastics, that are conventionally used as glazings.

Various polymer sheet and/or laminated glass characteristics and measuring techniques will now be described for use with the present invention.

The clarity of a polymer sheet can be determined by measuring the haze value, which is a quantification of the scattered light by a sample in contrast to the incident light. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, and less than 1%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17° C. (°F.) and manually pummeled with a hammer to break the glass. All broken glass that is not adhered to the poly(vinyl butyral) sheet is then removed, and the amount of glass left adhered to the poly(vinyl butyral) sheet is visually compared with a set of standards. The standards correspond to a scale in which varying degrees of glass remain adhered to the poly(vinyl butyral) sheet. In particular, at a pummel standard of zero, no glass is left adhered to the poly(vinyl butyral) sheet. At a pummel standard of 10, 100% of the glass remains adhered to the poly(vinyl butyral) sheet. For laminated glass panels of the present invention, various embodiments have a pummel of at least 3, at least 5, at least 8, at least 9, or 10. Other embodiments have a pummel between 8 and 10, inclusive.

The “yellowness index” of a polymer sheet can be measured according to the following: transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness. In various embodiments of the present invention, a polymer sheet can have a yellowness index of 12 or less, 10 or less, or 8 or less.

### EXAMPLES

### Example 1

A composition of 100 grams of ethylene-vinyl acetate copolymer having 29.5 weight percent of vinyl acetate and 0.1 grams of Millad® (3988 (available from Milliken & Company, Spartanburg, S.C.) is melt compounded, then melt-compressed at 165° C. into a 0.76 millimeter thick polymer sheet. The resulting sheet shows 2% haze.

### Example 2 (Comparative)

A composition of 100 grams of ethylene-vinyl acetate copolymer having 29.5 weight percent of vinyl acetate is melt-compressed at 165° C. into a 0.76 millimeter thick polymer sheet. The resulting sheet showed 6% haze.

### Example 3

A composition of 100 grams of ethylene-vinyl acetate copolymer having 22 weight percent of vinyl acetate and 0.1 grams of Millad 3988 is melt compounded, then melt-compressed at 165° C. into a 0.76 millimeter thick polymer sheet. The resulting sheet showed 6% haze.

### Example 4 (Comparative)

A composition of 100 grams of ethylene-vinyl acetate copolymer having 22 weight percent of vinyl acetate is melt-compressed at 165° C. into a 0.76 millimeter thick polymer sheet. The resulting sheet showed 20% haze.

By virtue of the present invention, it is now possible to provide interlayers having clarified ethylene-vinyl acetate copolymer that can provide processing and cost advantages over conventional ethylene-vinyl acetate copolymer and other types of polymer sheets.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed comprising ethylene-vinyl acetate copolymer with clarifying agent in any of the ranges given in addition to any of the ranges given for thickness, to form many permutations that are within the scope of the present invention.

Figures are understood to not be drawn to scale unless indicated otherwise.

Each reference, including journal articles, patents, applications, and books, referred to herein is hereby incorporated by reference in its entirety.

We claim:

1. An interlayer for use in a multiple layer glazing, comprising:
a first polymer sheet comprising ethylene-vinyl acetate copolymer and a reaction product of a di-substituted benzaldehyde and a polyhydric alcohol or polyhydric alcohol derivative.

2. The interlayer of claim 1, wherein said interlayer further compromises a second polymer sheet disposed in contact with said first polymer sheet, wherein said second polymer sheet comprises a polymer selected from the group consisting of poly(vinyl butyral), poly(vinyl chloride), poly(ethylene-co-vinyl acetate), poly(ethylene-co-ethyl acrylate), ionomers of partially neutralized ethylene/(meth)acrylic acid copolymer, polyethylene, polyethylene copolymers, and polyurethane.

3. The interlayer of claim 2, wherein said second polymer sheet comprises poly(vinyl butyral), ionomers of partially neutralized ethylene/(meth)acrylic acid copolymer, or polyurethane.

4. The interlayer of claim 2, wherein said interlayer further compromises a third polymer sheet disposed in contact with said first polymer sheet, wherein said third polymer sheet comprises a polymer selected from the group consisting of poly(vinyl butyral), poly(vinyl chloride), poly(ethylene-co-vinyl acetate), poly(ethylene-co-ethyl acrylate), ionomers of partially neutralized ethylene/(meth)acrylic acid copolymer, polyethylene, polyethylene copolymers, and polyurethane.

5. The interlayer of claim 4, wherein said second polymer sheet comprises poly(vinyl butyral), ionomers of partially neutralized ethylene/(meth)acrylic acid copolymer, or polyurethane.

6. The interlayer of claim 1, wherein said interlayer consists essentially of said first polymer sheet.

7. The interlayer of claim 1, wherein said reaction product is a reaction product of sorbitol and a di-substituted benzaldehyde.

8. The interlayer of claim 1, wherein said reaction product is 1,3:2,4-bis(3′4′-dimethylbenzylidene)sorbitol.

9. The interlayer of claim 1, wherein said ethylene-vinyl acetate copolymer comprises 0.05 to 3 phr of said reaction product.

10. The interlayer of claim 1, wherein said ethylene-vinyl acetate copolymer comprises 0.05 to 1 phr of said reaction product.

11. An interlayer for use in a multiple layer glazing, consisting essentially of a polymer sheet comprising ethylene-vinyl acetate copolymer and a reaction product of a di-substituted benzaldehyde and a polyhydric alcohol or polyhydric alcohol derivative.

12. The interlayer of claim 11, wherein said reaction product is a reaction product of sorbitol and a di-substituted benzaldehyde.

13. The interlayer of claim 12, wherein said reaction product is 1,3:2,4-bis(3′4′-dimethylbenzylidene)sorbitol.

14. The interlayer of claim 11, wherein said ethylene-vinyl acetate copolymer comprises 0.01 to 5 phr of said reaction product of sorbitol and a di-substituted benzaldehyde.

15. The interlayer of claim 11, wherein said ethylene-vinyl acetate copolymer comprises 0.05 to 1 phr of said reaction product of sorbitol and a di-substituted benzaldehyde.

16. A multiple layer glazing panel comprising an interlayer, wherein said interlayer comprises:
a first polymer sheet comprising ethylene-vinyl acetate copolymer and a reaction product of a di-substituted benzaldehyde and a polyhydric alcohol or polyhydric alcohol derivative.

17. The panel of claim 16, wherein said interlayer further compromises a second polymer sheet disposed in contact with said first polymer sheet, wherein said second polymer sheet comprises a polymer selected from the group consisting of poly(vinyl butyral), poly(vinyl chloride), poly(ethylene-co-vinyl acetate), poly(ethylene-co-ethyl acrylate), ionomers of partially neutralized ethylene/(meth)acrylic acid copolymer, polyethylene, polyethylene copolymers, and polyurethane.

18. The panel of claim 17, wherein said second polymer sheet comprises poly(vinyl butyral), ionomers of partially neutralized ethylene/(meth)acrylic acid copolymer, or polyurethane.

19. The panel of claim 17, wherein said interlayer further compromises a third polymer sheet disposed in contact with said first polymer sheet, wherein said third polymer sheet comprises a polymer selected from the group consisting of poly(vinyl butyral), poly(vinyl chloride), poly(ethylene-co-vinyl acetate), poly(ethylene-co-ethyl acrylate), ionomers of partially neutralized ethylene/(meth)acrylic acid copolymer, polyethylene, polyethylene copolymers, and polyurethane.

20. The panel of claim 19, wherein said third polymer sheet comprises poly(vinyl butyral), ionomers of partially neutralized ethylene/(meth)acrylic acid copolymer, or polyurethane.
